(19) United States
(12) Patent Application Publication
(10) Pub. No.: US 2026/0110311 A1
(43) Pub. Date: Apr. 23, 2026

(54) TWO STREAM DIFFUSER INTEGRATED AS A SINGLE UNIT FOR USE IN A TURBOFAN JET ENGINE

(71) Applicant: Beehive Industries, LLC, Centennial, CO (US)

(72) Inventor: Roy Fulayter, Avon, IN (US)

(21) Appl. No.: 19/414,752

(22) Filed: Dec. 10, 2025

Related U.S. Application Data
(63) Continuation of application No. PCT/US2024/060784, filed on Dec. 18, 2024.
(60) Provisional application No. 63/615,468, filed on Dec. 28, 2023.

(51) Int. Cl. F04D 29/54; F04D 19/00; B33Y 80/00

(52) U.S. Cl. CPC F04D 29/542; F04D 19/00; B33Y 80/00; F05D 2230/30; F05D 2240/12

(57) ABSTRACT

The two stream diffuser includes a core stream diffuser and a bypass stream diffuser, wherein the core stream diffuser and the bypass stream diffuser are three-dimensionally (3D) printed as an integral unit, which may also include compressor components. In some examples, the core stream diffuser and the bypass stream diffuser may include hollow vanes to permit engine services and/or instrumentation to pass through the diffuser. The core stream diffuser and the bypass stream diffuser may include radial channels and/or circumferential channels to permit fluid flow there-through, such as lubricants. A surge chamber may be provided as well as adjoining portholes. An interstage bypass bleed may be included that has at least two circumferential chambers configured to enable a substantially even pressure distribution at an offtake. In some examples, the integral unit may be additively 3D printed with metal.

### CROSS-REFERENCE TO RELATED APPLICATION

This application is a continuation application of and claims the benefit of International Application No. PCT/US2024/060784, filed December 18, 2024, which claims priority of Provisional Application No. 63/615,468, filed on December 28, 2023, the entire content of both applications is incorporated herein by reference as if fully set forth below in its entirety and for all applicable purposes.

### TECHNICAL FIELD

Aspects described herein are generally related to jet engines and more particularly related to turbofan jet engine diffusers that may be printed using a 3-D printing apparatus.

### BACKGROUND

Aspects described herein relate to jet engines. In general, jet engines, and in particular, turbofan jet engines, include rotating sets of blades referred to as rotors and/or impellers, and static sets of blades, referred to as stators and/or diffusers. In a turbofan jet engine, a first set of rotating blades may be fan blades that may be designed to push a large volume of air into two distinct regions. The regions may be referred to herein as a bypass air region and a core air region.

Within the core air region is a compressor apparatus, which is designed to compress air, mix the compressed air with fuel, ignite the air-fuel mixture, and expel the ignited air-fuel mixture from the jet engine exhaust. The bypass air region exists outside of, and is wrapped around, the core air region. Air pushed into the bypass air region bypasses the core air region and is expelled from the jet engine around and alongside the ignited air-fuel mixture ejected from the jet engine’s exhaust. The air leaves the compressor and enters the combustor where fuel is burned. The air and combustion products leave the combustor and rotate the turbine, which rotates the shaft, which rotates the compressor or fan blades. The exhaust air from the core air region and the air pushed through the bypass air region by the fan blades produce thrust. The combined thrust propels the jet engine (and the aircraft to which it is attached) forward.

Engineers and scientists engage in ongoing work to improve the efficiency of jet engines and reduce their parts count.

### BRIEF SUMMARY

The following summary is provided to facilitate an understanding of some of the innovative features unique to the examples disclosed and is not intended to be a full description. A full appreciation of the various aspects of the examples can be gained by taking the entire specification, claims, drawings, and abstract as a whole.

In one example, an apparatus for use in a turbofan jet engine is described. The apparatus includes a core stream diffuser and a bypass stream diffuser, wherein the core stream diffuser and the bypass stream diffuser are formed as an integral unit. In some examples, the integral unit may include additional components such as a compressor case. In some examples, the integral unit is three-dimensionally (3D) printed with metal. In some examples, one or both of the core stream diffuser and the bypass stream diffuser may include hollow vanes to permit engine services and/or instrumentation components to pass through the diffuser. One or both of the core stream diffuser and the bypass stream diffuser may include a radial channel and/or a circumferential channel to permit fluid flow there-through, such as lubricants. A surge chamber may be provided, as well as one or more portholes. An interstage bypass bleed may be included that has at least two circumferential chambers configured to enable a substantially even pressure distribution at an offtake.

In one example, a method is provided for fabricating or otherwise providing an apparatus for use in a turbofan jet engine. The method includes forming a core stream diffuser and a bypass stream diffuser, wherein the core stream diffuser and the bypass stream diffuser are formed as an integral unit. In some aspects, the integral unit may be formed to include additional components such as a compressor case. In some examples, the integral unit is 3D printed with metal. In some examples, one or both of the core stream diffuser and the bypass stream diffuser are formed to include hollow vanes to permit engine services and/or instrumentation components to pass through the diffuser. One or both of the core stream diffuser and the bypass stream diffuser may be formed to include a radial channel and/or a circumferential channel to permit fluid flow there-through. At least one surge chamber may also be formed. One or more portholes may also be formed. An interstage bypass may be formed, the interstage bypass comprising circumferential chambers configured to enable a substantially even pressure distribution at an offtake.

In one example, an apparatus is provided for use in a turbofan jet engine. The apparatus includes: means for diffusing a core air stream and means for diffusing a bypass air stream, wherein the means for diffusing the core air stream and the means for diffusing the bypass air stream are an integral unit, which, may be 3D printed using metal.

### BRIEF DESCRIPTION OF THE DRAWINGS

The accompanying figures, in which like reference numerals refer to identical or functionally similar elements throughout the separate views and which are incorporated in and form a part of the specification, further illustrate the examples and, together with the detailed description, serve to explain the aspects disclosed herein.

FIG. 1 is a partial cutaway cross-section right-side view of a portion of a turbofan jet engine according to some aspects of the disclosure.

FIG. 2A is a partial cutaway cross-section right-side view of an apparatus according to some aspects of the disclosure, including an integrated diffuser and compressor case.

FIG. 2B is top-right-front-perspective view of the apparatus of FIG. 2A according to some aspects of the disclosure.

FIG. 3 is a partial cutaway cross-section right-side view of an apparatus according to some aspects of the disclosure, highlighting certain features.

FIG. 4 is a perspective view of a bypass vane of an apparatus according to some aspects of the disclosure.

FIG. 5 is a perspective view of a core vane of an apparatus according to some aspects of the disclosure.

FIG. 6 is a partial cutaway cross-section right-side view of a top half portion of an apparatus illustrating various features, according to some aspects of the disclosure.

FIG. 7 is a partial cutaway cross-section perspective view of a portion of the apparatus of FIG. 6, illustrating various features, according to some aspects of the disclosure.

FIG. 8A is a partial perspective view of a portion of the apparatus of FIG. 6, illustrating a radial line-of-sight channel, according to some aspects of the disclosure.

FIG. 8B is a partial cutaway view of a portion of the apparatus of FIG. 6, illustrating an interior portion of the radial channel of FIG. 8A, according to some aspects of the disclosure.

FIG. 9 is a partial perspective cutaway view of the apparatus of FIG. 6, according to some aspects of the disclosure, particularly illustrating bypass airflow channels and circumferential stops.

FIG. 10 is an aft view (taken along the longitudinal axis) of a portion of the apparatus of FIG. 6, according to some aspects of the disclosure, highlighting fluid flow circuits.

FIG. 11 is a block diagram summarizing an embodiment in accordance with aspects of the disclosure wherein a turbofan jet engine includes N stages of integrated diffusers.

FIG. 12 summarizes a method in accordance with aspects of the disclosure for fabricating an integrated diffuser using 3D printing for use in a turbofan jet engine or elsewhere.

### DETAILED DESCRIPTION

The particular values and configurations discussed in the following non-limiting examples can be varied and are cited merely to illustrate one or more examples and are not intended to limit the scope thereof.

Examples will now be described more fully hereinafter with reference to the accompanying drawings. The examples disclosed herein can be modified within the scope of this disclosure and should not be construed as being limiting; rather, these examples are provided so that this disclosure will be thorough and complete, and will fully convey the scope of the disclosure to persons of ordinary skill in the art. Like numbers refer to like elements throughout.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to persons having ordinary skill in the art that these concepts may be practiced without these specific details. In some examples, well-known structures and components are shown in block diagram form in order to avoid obscuring such concepts.

The terminology used herein is for the purpose of describing particular examples only and is not intended to be limiting. As used herein, the singular forms "a", "an", and "the" are intended to include the plural forms as well, unless the context clearly indicates otherwise. It will be further understood that the terms "comprise" and/or "comprising," when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one example” as used herein does not necessarily refer to the same example and the phrase “in another example” as used herein does not necessarily refer to a different example. It is intended that the scope of disclosure may encompass subject matter of one or more examples in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that particular examples described herein are shown by way of illustration and not as limitations. Aspects described herein can be employed in various examples without departing from the scope of the disclosure. Those skilled in the art will recognize or be able to ascertain using no more than routine experimentation, numerous equivalents to the specific aspects and procedures described herein. Such equivalents are considered to be within the scope of this disclosure and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more items or terms, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the aspects disclosed and claimed herein can be made and executed without undue experimentation in light of the present disclosure. While the aspects have been described in terms of preferred examples, it will be apparent to those of skill in the art that variations may be applied to the aspects described herein without departing from the concept, spirit, and scope of the disclosure and claims. All such similar substitutes and modifications apparent to those skilled in the art are deemed to be within the spirit, scope, and concept of the disclosure as defined by the appended claims.

In some examples, jet engine rotor blades and diffuser blades, along with the shaft and cowlings or other ducts and channels of the jet engine are made of metal. However, they may be made of other materials such as, for example, and without limitation, composite materials, carbon fiber, or plastic. Often, metal parts are machined from solid billets of metal, or they may be made of sheet metal or metal plates that may be braised or welded together. Often individual blades of the fan, and individual compressor blades, are manufactured, inspected to exacting tolerances, and individually inserted into a rotatable structure (e.g., a disk-shaped rotatable structure) that is coupled to a jet engine shaft. The work is exacting, requires great care and precision, and is time-consuming and expensive. A suitable metal is Ti-6Al-4V (UNS designation R56400), also sometimes called TC4, Ti64, or ASTM Grade 5, which is an alpha-beta titanium alloy with a high specific strength and excellent corrosion resistance. Herein, this metal is simply referred to as Ti64. Other metals might be used instead, such as steel or nickel-based metals.

Described herein are three-dimensional (3D) printed components for jet engines, including integrated diffusers that include a core stream diffuser and a bypass stream diffuser, with the core stream diffuser and the bypass stream diffuser being 3D printed as an integral unit. The integral unit may include additional components such as compressor components. The 3D printing may be performed using 3D printed metal. The apparatus may be configured to operate in rigorous, high mechanical stress and high rotational speed demanding applications. The apparatus is structurally rigid to withstand the engine front bearing loads that pass through this part and react against the engine mounts. Certain applications of the apparatus include military applications in which the jet engine utilizing a diffuser such as those exemplified herein may propel a weapon and may need to operate for several hours.

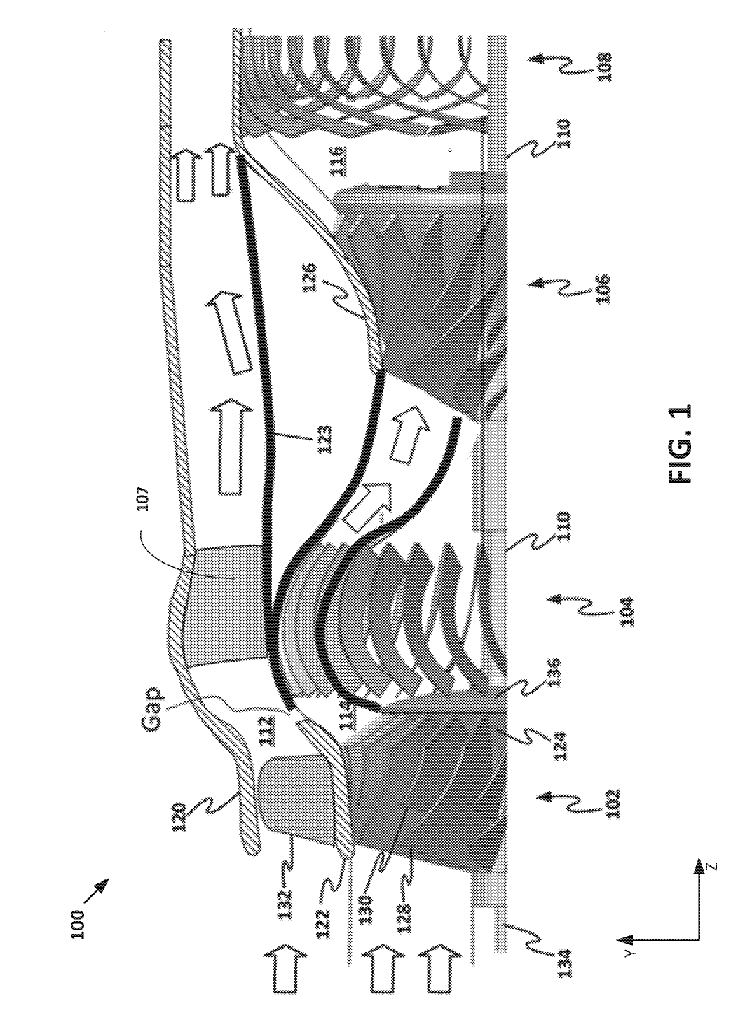

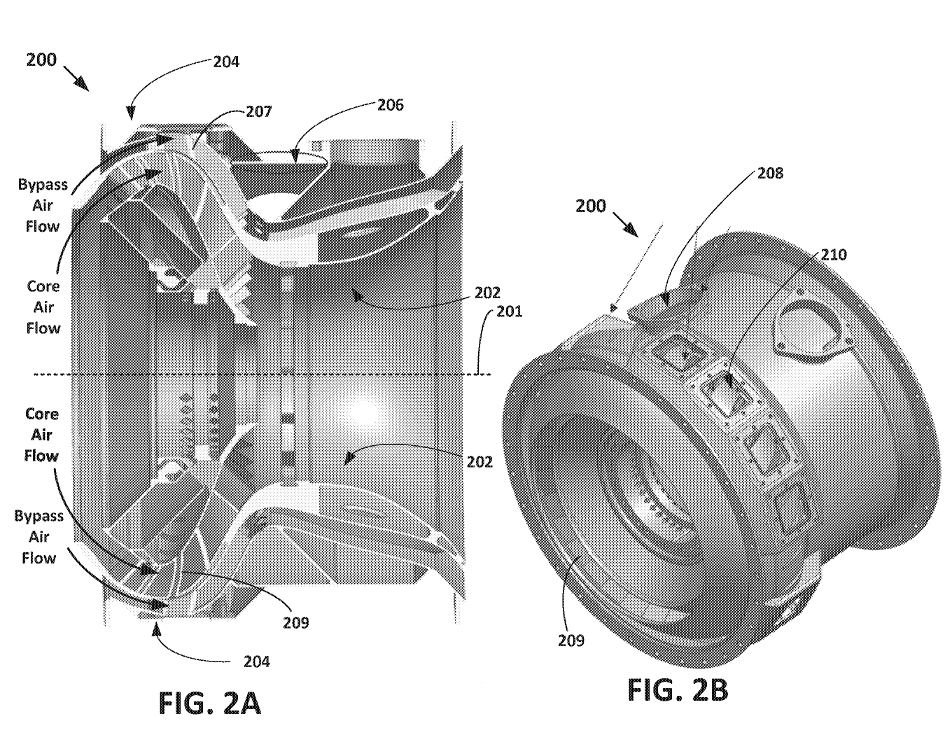

FIG. 1 is a partial cutaway cross-section right-side view of a portion of a turbofan jet engine 100, according to some aspects of the disclosure, with first and second diffusers 104 and 108. Although not shown in FIG. 1, both the first diffuser 104 and the second diffuser 108 may be configured with core stream diffuser vanes and bypass stream diffuser vanes integrated as a single unit. (See the other figures discussed below, such as FIG. 2.) Note that FIG. 1 is intended to provide an overview of a turbofan jet engine that includes diffusers but is not intended to illustrate preferred shapes for the core stream and bypass stream diffuser portions nor the integration of the core stream and bypass stream diffuser portions, which is shown in the other figures of the application, discussed below.

There is no limit to the number of stages of the turbofan jet engine 100. The illustrated features of the turbofan jet engine 100 include an impeller 102 (also referred to as a rotor), the first diffuser 104 (also referred to as a first stage stator), a compressor impeller 106 (also referred to as a compressor rotor), and the second stage diffuser 108 (also referred to as a second stator), and a compressor shaft 110. As noted, although not explicitly shown in FIG. 1, each of the diffusers 104 and 108 may be 3D printed as an integral unit, in accordance with aspects of the disclosure. The diffusers are not limited to being manufactured of metal but may be made of other materials such as, for example, and without limitation, composite materials, carbon fiber, or plastic.

Air, represented by block arrows, enters the impeller 102 and is divided into a first stream that enters a bypass air region 112 and a second stream that enters a core air region 114. Air entering the core air region 114 is directed to the compressor impeller 106 and emerges from the compressor rotor in compressed air region 116. Air in the bypass air region 112 is directed along the bypass channel as shown by the arrows. In the particular example of FIG. 1, a rotating shroud 122 is shown, but it should be understood that most engines with bypass do not have a rotating shroud. Typically the dividing line between the core and bypass flow occurs just upstream of the core stream diffuser (core vane or engine section stator) and the bypass stream diffuser (bypass vane).

In the example of FIG. 1, the facing walls of an outer cowling 120 and the shroud 122 define some borders of the bypass air region 112 adjacent to the shroud and within a region occupied by the bypass blade 132 of the impeller 102. Facing walls of the stationary outer cowling 120 and a first inner wall 123, deeper within the jet engine 100, define additional borders of the bypass air region 112. Facing walls of the shroud 122 and a hub 124 define some borders of the core air region 114 within a region occupied by the core blades 128 and splitter blades 130 of the impeller 102. A second inner wall 126 may define an outer border of the core air region 114 deeper within the jet engine 100. The compressed air region 116 follows the compressor impeller 106. A gap (e.g., a spaced-apart configuration) exists between the shroud 122 and a leading edge 125 (formed at a junction of the first inner wall 123 and the second inner wall 126). The leading edge 125, the first inner wall 123, the second inner wall 126, and the first diffuser 104 may be fixed to one another and remain stationary relative to the shroud 122. The shroud 122 may be axisymmetric. The shroud 122 may serve as a dividing wall between the bypass air region 112 and the core air region 114. As shown, a strut 107 may be formed within the bypass flow channel 112 to hold outer cowling 120 and shroud 122 together. Although not shown, another strut may be provided within the flow channel 112 closer to the second stage diffuser 108. Other struts may be provided as well.

As used herein, without any limiting intentions, the bypass air stream (also known as the hub bypass and tip bypass) refers to the air flowing within the bypass air region 112. As used herein, without any limiting intentions, the core air stream (also known as the hub core and tip core) refers to the air drawn into the impeller 102 via the set of core blades 128, flowing within the core air region 114. Core air is directed to a core of a turbofan jet engine.

Note that FIG. 1 illustrates one example of a turbofan engine. Various modifications can be made to various features to achieve desired parameters, such as pressure ratios, compressor efficiency, etc. For example, the size of the bypass stream 112 may be increased by spacing the outer cowling 120 and shroud 122 farther apart. The spanwise lengths of components 107 and 132 may be correspondingly increased.

Having described an exemplary turbofan engine, the following descriptions will now focus on a diffuser that includes a core stream diffuser and a bypass stream diffuser, with the core stream diffuser and the bypass stream diffuser 3D printed as an integral unit. The integral unit may additionally include compressor components such as a compressor case.

FIG. 2A illustrates a side cutaway view (partially in cross-section) of an integrated apparatus 200, according to some aspects of the disclosure, which includes a bypass/core diffuser formed as a single unit. In FIG. 2A the cross-section is taken vertically through the longitudinal axis 201 of the apparatus. FIG. 2B illustrates a perspective of the apparatus 200, according to some aspects of the disclosure. The apparatus 200 may be fitted within a turbofan jet engine, such as an engine generally of the type shown in FIG. 1. Notably, the entire apparatus 200 of FIGS. 2A and 2B may be 3D printed as a single component. As such, FIGS. 2A and 2B illustrate an apparatus for use in a turbofan jet engine, where the apparatus includes at least a core stream diffuser and a bypass stream diffuser, with the core stream diffuser and the bypass stream diffuser 3D printed as an integral unit. The apparatus may additionally include other components such as compressor case components.

An inner circumferential portion of the apparatus 200 represents the core diffuser portion 202 (through which core airflow (or gas) passes, corresponding to the core region discussed above) and an outer circumferential portion represents the bypass diffuser portion 204 (through which a bypass airflow (or gas) passes, corresponding to the bypass air region discussed above). As such, outer portions of the core diffuser portion 202 form inner portions of the bypass diffuser portion 204, and vice versa. Each of the two diffuser portions (core and bypass) includes diffuser blades, e.g., blades or vanes 207 and 209, which appear in cross-section in FIG. 2A. Some of the blades or vanes (such as blade 209) and other portions of the apparatus 200 may be hollow to permit engine services and/or instrumentation components to be inserted into or to pass through the diffuser. That is, one or both of the core stream diffuser portion and the bypass stream diffuser portion may include hollow portions to permit engine services and/or instrumentation components to pass through the diffuser. By providing hollow vanes or blades, one or more struts may be omitted, which should enable providing a higher surge margin for the overall compressor.

Note that the configuration of FIGS. 2A and 2B is merely exemplary. Some of the features shown in the figures might be omitted within production models, depending, e.g., on the bearing lubrication. For example, FIG. 2A illustrates an outer wall 206 that might be omitted in a production model. FIG. 2B illustrates a bypass bleed port or porthole 208 that might be omitted in a production model. FIG. 2B also illustrates various manifolds 210, some or all of which may be omitted in a production model. Still further, in other examples, the bypass channel may be enlarged or reduced. In FIG. 2A, the bypass vane 207 may be extended radially for use with higher bypass flow rates. In other examples, the bypass vane 207 may be reduced radially for use with lower bypass flow rates. In some examples, the bypass flow path goes back axially rather than conforming to the core flow path. In such a layout, strut 207 may be positioned further to the right within the drawing.

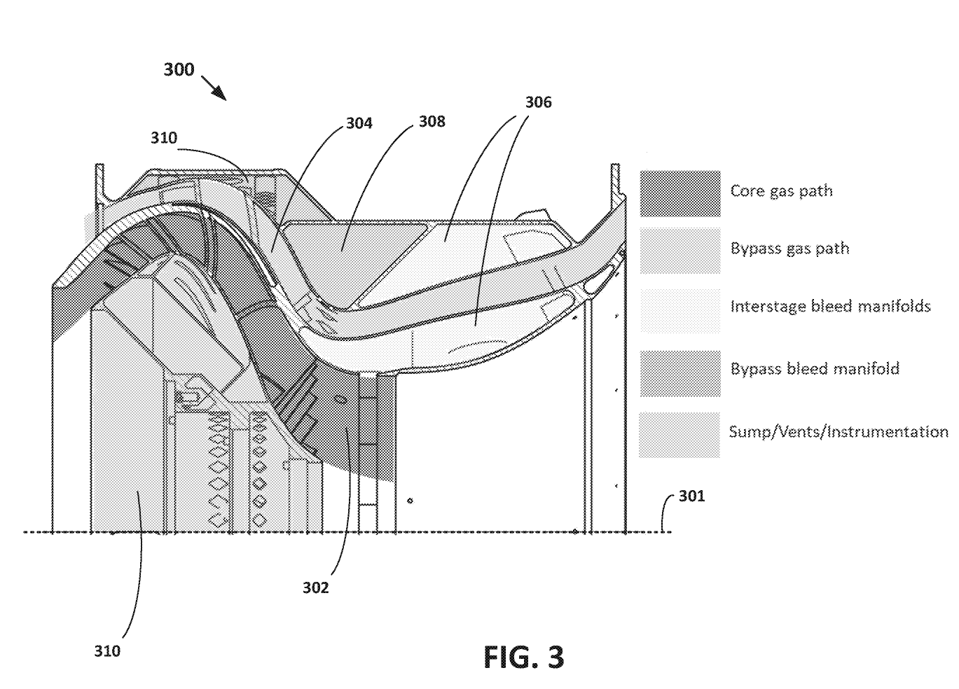

FIG. 3 illustrates another side cutaway view (partially in cross-section) of an apparatus 300 having an integrated core/bypass diffuser, according to some aspects of the disclosure, with this figure showing only a top half slice of the apparatus. The cross-section is taken vertically through the longitudinal axis 301 of the apparatus. A first shaded portion 302 corresponds to the core gas path. A second shaded portion 304 corresponds to the bypass gas path. A third shaded portion 306 corresponds to interstage bleed manifolds. As discussed above in connection with FIG. 1, a jet engine may have two diffusers, arranged in two stages, with each diffuser being an integrated diffuser having both a core and bypass portion. Interstage thus refers generally to portions that may be downstream relative to other components. In the case of the interstage bleed manifolds 306, these manifolds are downstream from the main core gas path diffuser components providing core gas path 302. A fourth shaded portion 308 corresponds to bypass bleed manifolds. A fifth shaded portion 310 corresponds to sumps/vents/instrumentation portion of the compressor case portion of the apparatus. Note that instrumentation may include, e.g., wires for carrying signals for sensors or the like and/or conduits for carrying certain fluids used in lubrication. Note also that with this design, various struts that would otherwise be needed may be omitted. Avoiding struts and passing services and instrumentation without a strut may provide a performance advantage to the compressor. This can serve to increase a compressor surge margin (by the decrease in the strut wake depth and a typical vane wake) to enable operation at somewhat higher efficiencies by using an elevated operating line.

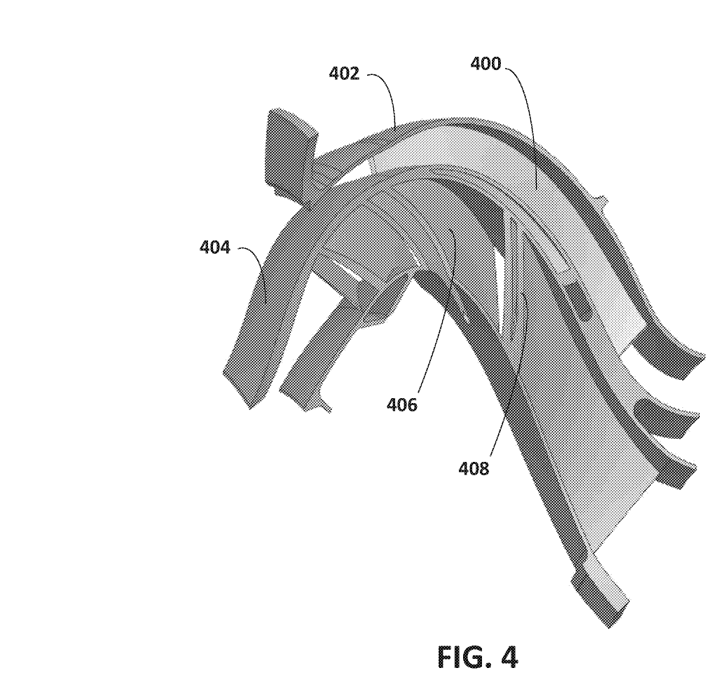

FIGS. 4-10 illustrate portions of the apparatus with integrated diffuser components, according to some aspects of the disclosure, while highlighting various features.

FIG. 4 is a perspective view illustrating the shape of a bypass vane 400, according to some aspects of the disclosure, of the bypass portion of the apparatus of FIGS. 2A and 2B (while omitting most of the compressor case). The bypass vane 400 is formed between a portion of the exterior casing 402 of the diffuser and a separator portion 404 that separates the bypass airflow path from the core airflow path with its various core vanes, such as 406 and 408. Note that some of the bypass and core vanes, such as vane 408, may be hollow to permit fluid flow, such as lubricant flow. The separator 404 may also include hollow portions or conduits to permit air flow interchange between the bypass and core.

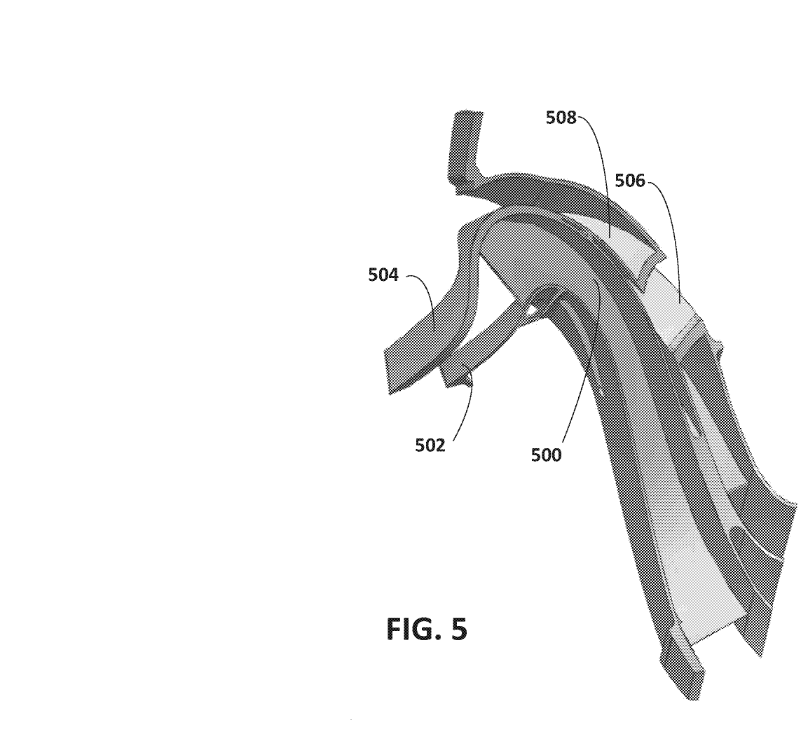

FIG. 5 is a perspective view illustrating the shape of a core vane 500, according to some aspects of the disclosure, of the core portion of the apparatus of FIGS. 2A and 2B (while omitting most of the diffuser). The core vane 500 is formed between a portion of an exterior separator 502 of the compressor case and a separator 504 that separates the core airflow path from the bypass airflow path with its various core vanes, such as 506 and 508. Note that separator 504 may include hollow portions or conduits to permit air flow interchange between the bypass and core.

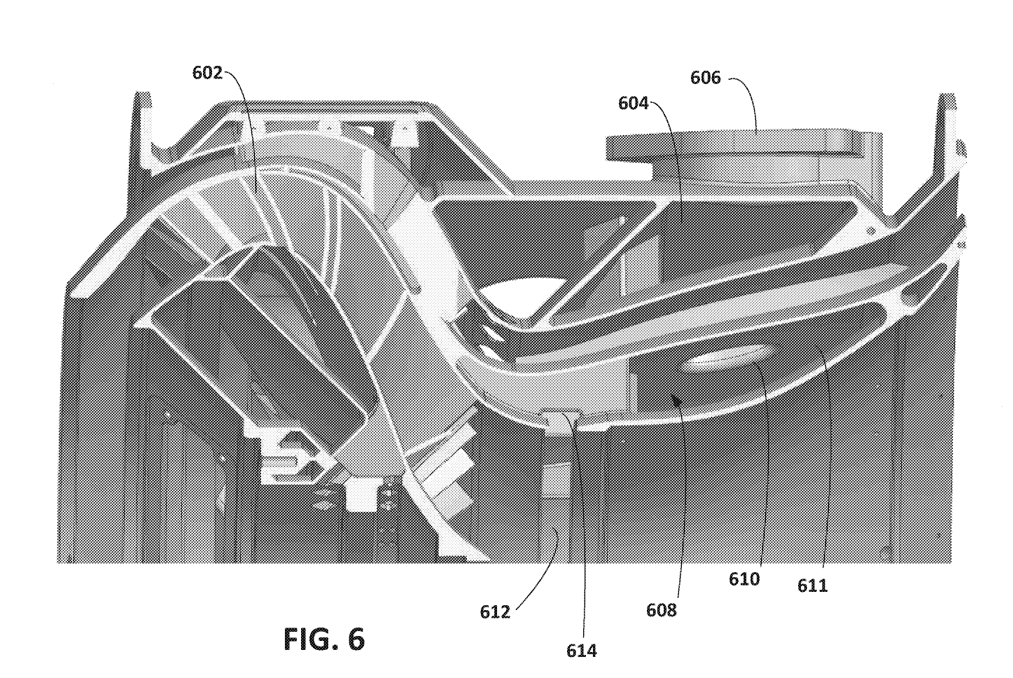

FIG. 6 is a partial side cutaway view of the apparatus of FIGS. 2A and 2B (taken parallel with the longitudinal axis) illustrating various features, according to some aspects of the disclosure. Again, note the hollow vanes 602 within the core diffuser portion. FIG. 6 also highlights a circumferential outer bleed manifold 604 and a bleed valve offtake flange 606. An inner circumferential manifold 608 is also shown. A bypass strut pass through 610 passes through the inner manifold 608 and may be one of eight such pass-throughs within the diffuser. An interstage bypass bleed port 612 includes a mouth 614. Thus, FIG. 6 illustrates an interstage bypass bleed that includes two circumferential manifolds or chambers (chamber 604 and 608) configured to enable a substantially even pressure distribution at the offtake (mouth) of the interstage bypass bleed port 612. As noted above, the integrated diffuser design uses vanes that are hollow to permit engine services and instrumentation to pass without requiring corresponding struts which should deliver a higher surge margin for the compressor. Nevertheless, at least some struts are employed in the design through which bypasses may be formed, where appropriate. See, for example, strut 611 through which the pass-through hole 610 is formed.

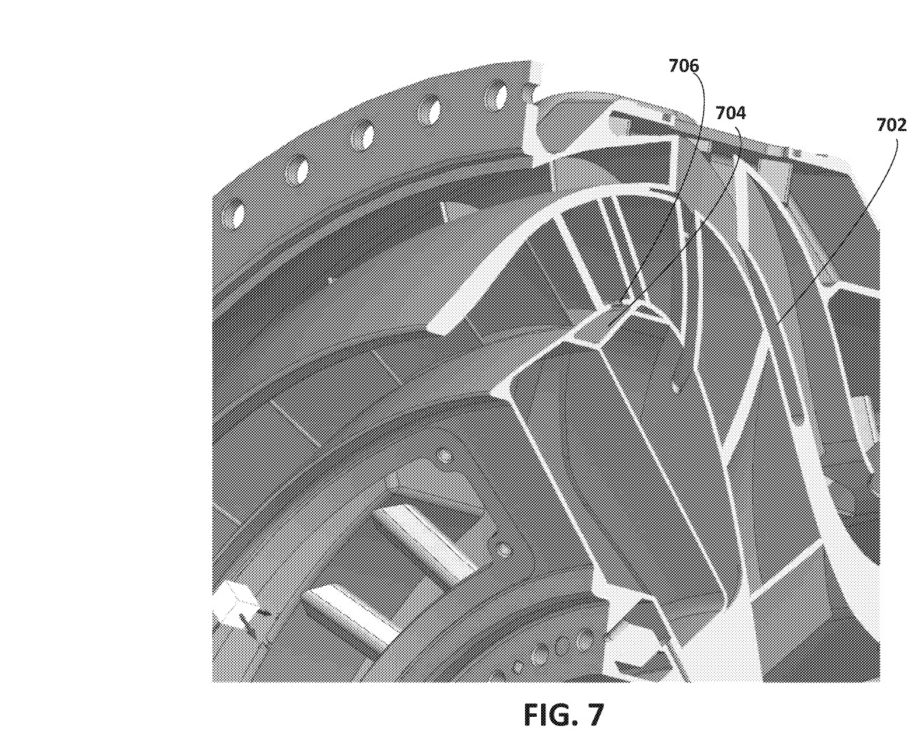

FIG. 7 is a partial side cutaway view of the apparatus of FIGS. 2A and 2B (taken at an angle relative to the longitudinal axis) illustrating an inner circumferential channel 702, according to some aspects of the disclosure, which allows fluid flow (e.g. lubrication) to pass between the core and bypass portions. FIG. 7 also shows a surge chamber 704 connected via a porthole 706 to a chamber of the core diffuser. The surge chamber helps to equalize pressure to reduce the risk of an engine stall. Note that the location of the surge chamber 704 of FIG. 7 is merely exemplary and the port hole 706 may be located elsewhere within the core diffuser. In some examples, a similar port hole might be provided within the bypass diffuser.

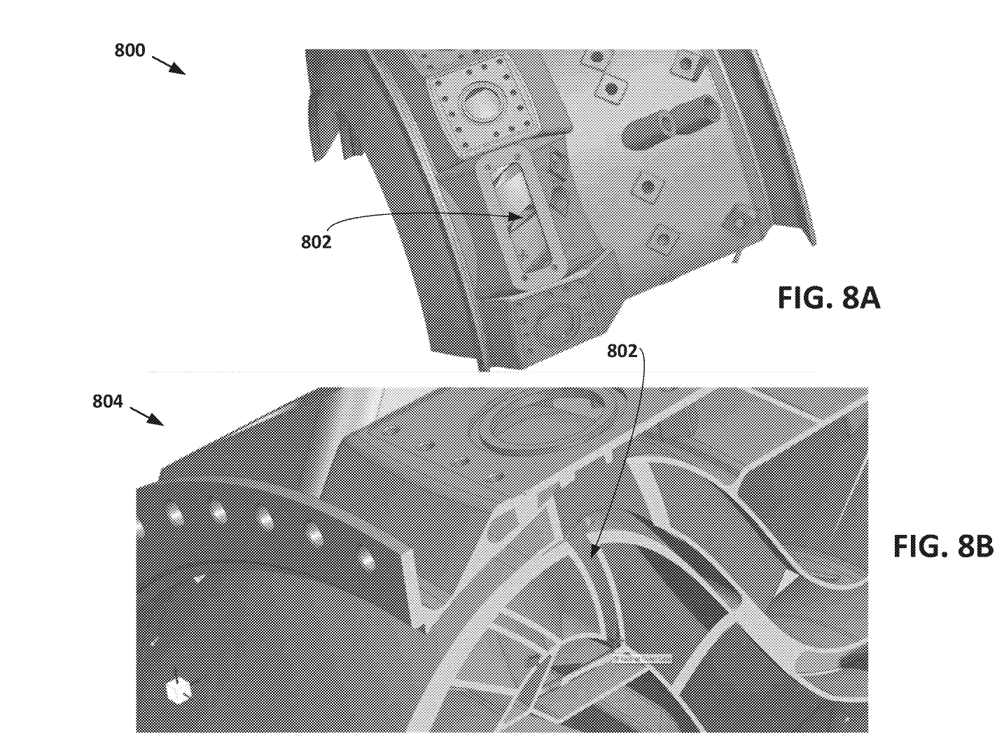

FIG. 8A is a partial perspective view 800 of the apparatus of FIGS. 2A and 2B illustrating a portion of a radial "line-of-sight" channel 802, according to some aspects of the disclosure, which allows for fluid flow to pass radially through the apparatus between exterior and interior portions of the diffuser. Channel 802 is referred to herein as a line-of-sight channel since at least a portion of the channel is visible from the exterior of the apparatus. FIG. 8B is a partial cutaway view 804 showing an interior portion of the radial channel 802. These radial or axial channels are in addition to the circumferential channels shown in FIG. 7 and discussed above. As such, one or both of the core stream diffuser and the bypass stream diffuser may include radial channels and/or circumferential channels to permit fluid flow there-through. The fluid may be, for example, a lubrication fluid. For lubrication, the channels may be configured and positioned to feed the lubricant to bearings (not shown).

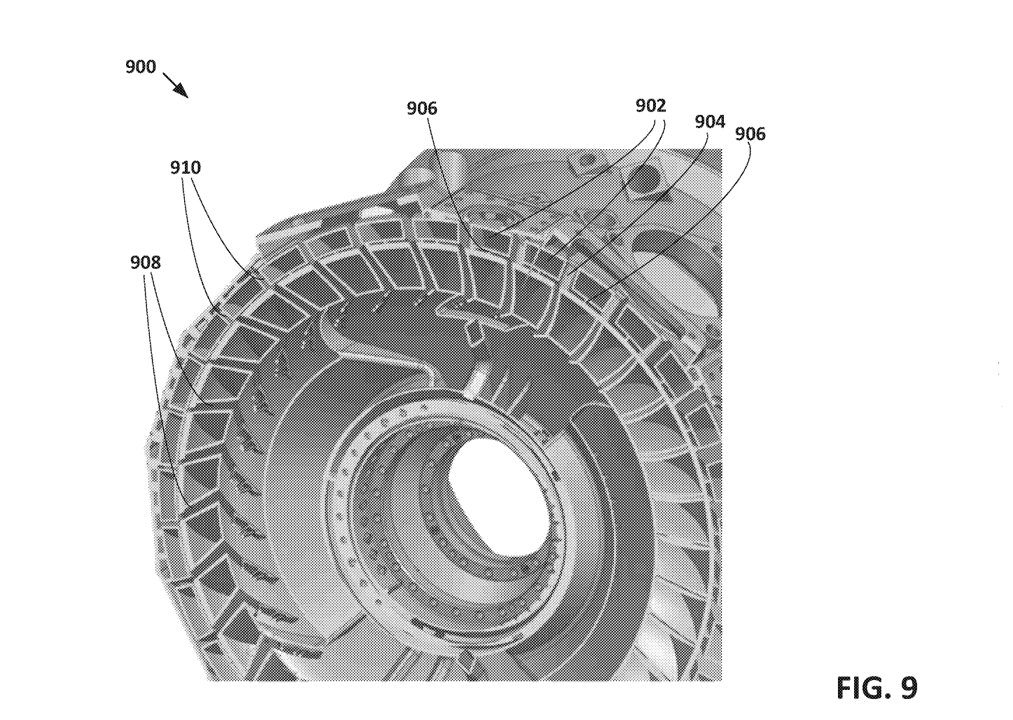

FIG. 9 is a partial cutaway view 900 of a portion of the apparatus of FIGS. 2A and 2B, according to some aspects of the disclosure, particularly illustrating bypass airflow channels 902 and instrumentation channels and lubricant flow channels or pipes 904 therebetween. The figure also illustrates circumferential (or axial) stops 906 that block instrumentation fluid (e.g., lubricant) flow to prevent the fluids from escaping from their designated channels or pipes. That is, the stops constrain the flow of lubricants to the appropriate channels. Still further, FIG. 9 illustrates that both the bypass portion of the diffuser and the core portion include the same number of vanes (which may be hollow), such as 32 vanes in the bypass diffuser portion and 32 vanes in the core diffuser portion. In other examples, the count of vanes in the bypass and core may differ. Illustrative vanes of the core diffuser portion are identified by reference numerals 908. Illustrative vanes of the bypass diffuser portion are identified by reference numerals 910. The vanes need not be uniformly spaced around the circumference of the apparatus. Indeed, it can be advantageous that the vanes are not uniformly spaced (e.g., with some random variations in spacing). In this regard, the number of vanes is referred to as the engine order and hence an engine (or compressor) with 32 vanes has an engine order of 32. By positioning the vanes non-uniformly around the circumference of the apparatus, a vibrational amplitude can be reduced to reduce the risk of stress damage to the parts by reducing or minimizing forced response on upstream and downstream rotors. In some examples, a circumferential delta angle of some vanes is increased slightly and others is decreased slightly to provide the uneven spacing.

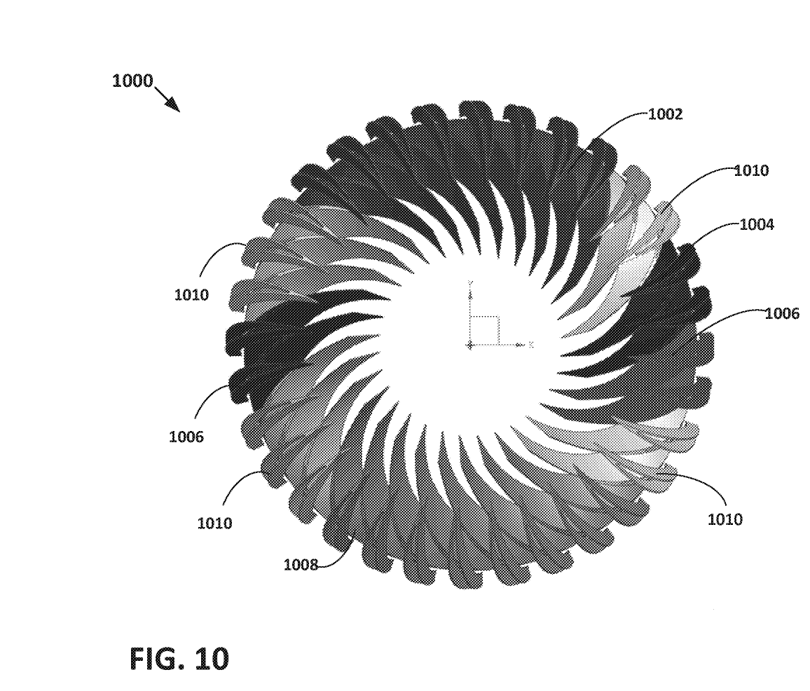

FIG. 10 is an aft view (taken along the longitudinal axis of the diffuser) of a portion of the sumps, vents, and instrumentation portion 1000 of the apparatus FIGS. 2A, 2B, and 3, according to some aspects of the disclosure, highlighting fluid flow circuits within that portion of the apparatus. A first shaded portion 1002 corresponds to sump fluid flow conduits. A second shaded portion 1004 corresponds to lubricant fluid flow conduits. A third shaded portion 1006 corresponds to additional sump fluid flow conduits. A fourth shaded portion 1008 corresponds to sump scavenge fluid flow conduits. Other shaded portions 1010 correspond to instrumentation conduits. Although not shown, panels or vents might be provided on the external circumference to facilitate the inlet and outlet of the fluids.

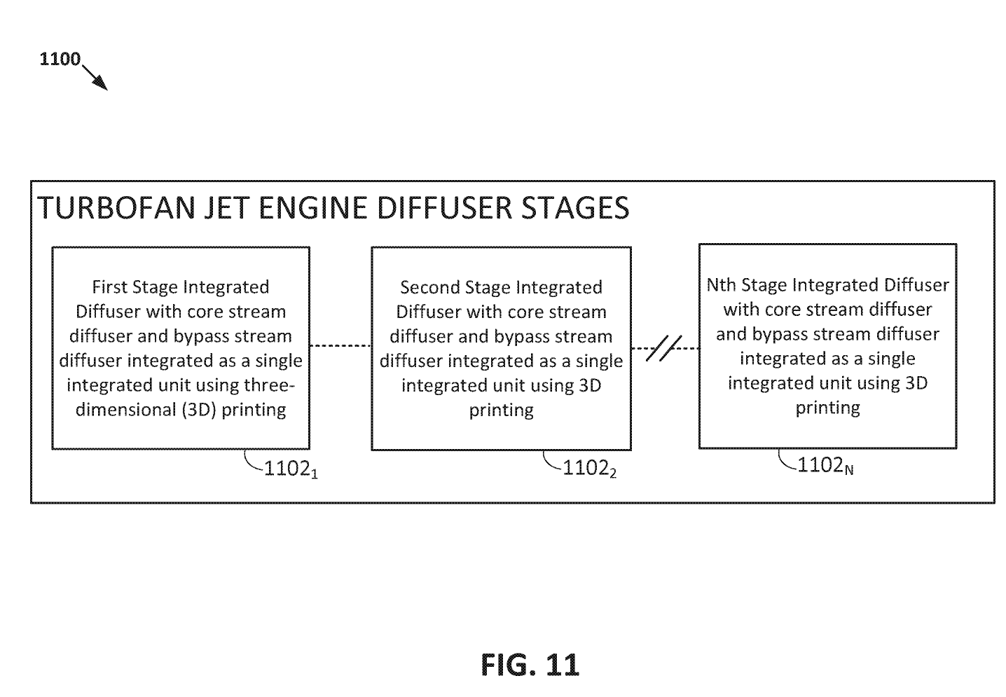

FIG. 11 is a block diagram summarizing an embodiment in accordance with aspects of the disclosure wherein a turbofan jet engine 1100 may include a series of N integrated diffusers, each having a core stream diffuser and a bypass stream diffuser integrated as a single integrated unit using 3D printing (and which may also include compressor components). That is, the turbofan jet engine 1100 has a first-stage integrated diffuser 1102₁, a second-stage integrated diffuser 1102₂, and so on, up to an Nth-stage integrated diffuser 1102_{N}. N may be, for example, 3, but may include more or fewer stages. Note that, in FIG. 11, the other components of the turbofan jet engine 1100, such as impellers, are not shown.

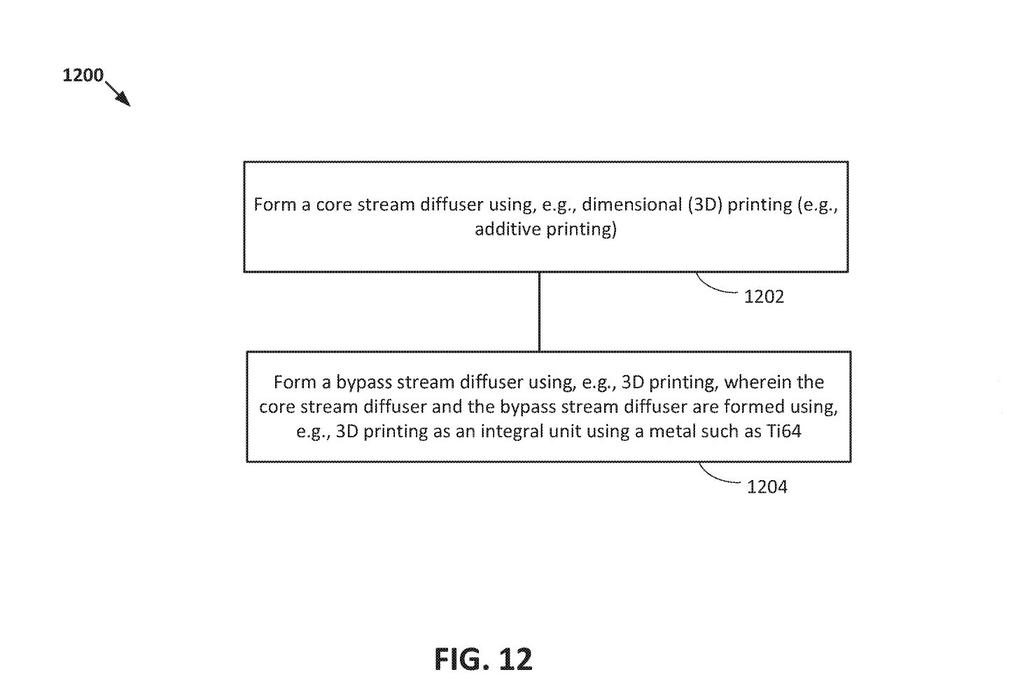

FIG. 12 summarizes a method 1200 in accordance with aspects of the disclosure for fabricating an integrated diffuser for use in a turbofan jet engine or elsewhere. Briefly, at block 1202, a 3D printer is used to form a core stream diffuser using, e.g., 3D printing, and at block 1204, the 3D printer is also used to form a bypass stream diffuser using, e.g., 3D printing; wherein the core stream diffuser and the bypass stream diffuser are formed using, e.g., 3D printing as an integral unit. The fabricated apparatus may also include other components such as compressor components. Note that since the resulting apparatus includes an integrated diffuser, the fabrication steps need not be performed in the order shown. That is, the core stream diffuser and the bypass stream diffuser may be formed at the same time. Any suitable 3D printing procedure may be used, such as additive manufacturing (AM), e.g. Laser Powder Bed Fusion, LPBF or Electron Beam Powder Bed Fusion, EBPBF.

Note that although illustrative core diffuser components and bypass diffuser components are described herein, these are exemplary and, in some aspects, a means for diffusing a core air stream may be provided along with a means for diffusing a bypass air stream, wherein the means for diffusing the core air stream and the means for diffusing the bypass air stream are 3D printed as an integral unit.

The word "exemplary" is used herein to mean "serving as an example, instance, or illustration." Any aspect described herein as "exemplary" is not necessarily to be construed as preferred or advantageous over other aspects. Likewise, the term "aspects" does not require that all aspects include the discussed feature, advantage, or mode of operation.

While the above descriptions contain many specific embodiments, these should not

While the above descriptions contain many specific embodiments, these should not be construed as limitations on the scope of the disclosure, but rather as examples of specific embodiments thereof. Moreover, reference throughout this specification to "one embodiment," "an embodiment," or similar language means that a particular feature, structure, or characteristic described in connection with the embodiment is included in at least one embodiment of the present disclosure. Thus, appearances of the phrases "in one embodiment," "in an embodiment," and similar language throughout this specification may, but do not necessarily, all refer to the same embodiment, but mean "one or more but not all embodiments" unless expressly specified otherwise.

1. An apparatus for use in a turbofan jet engine, the apparatus comprising:
a core stream diffuser; and
a bypass stream diffuser;
wherein the core stream diffuser and the bypass stream diffuser are an integral unit.

2. The apparatus of claim 1, wherein the core stream diffuser and the bypass stream diffuser comprise a three-dimensionally (3D) printed integral unit.

3. The apparatus of claim 2, wherein the integral unit is 3D printed with metal.

4. The apparatus of claim 1, wherein the integral unit includes compressor components.

5. The apparatus of claim 1, wherein one or both of the core stream diffuser and the bypass stream diffuser include hollow vanes to permit engine services and/or instrumentation components to pass through.

6. The apparatus of claim 1, wherein one or both of the core stream diffuser and the bypass stream diffuser include a radial channel and/or a circumferential channel to permit fluid flow there-through.

7. The apparatus of claim 1, further comprising at least one surge chamber.

8. The apparatus of claim 1, wherein the core stream diffuser and the bypass stream diffuser each include a plurality of vanes that are not uniformly spaced.

9. The apparatus of claim 1, further comprising an interstage bypass bleed comprising first and second circumferential chambers configured to enable a substantially even pressure distribution at an offtake.

10. A turbofan jet engine including the apparatus of claim 1.

11. A method for providing an apparatus for use in a turbofan jet engine, the method comprising:
forming a core stream diffuser; and
forming a bypass stream diffuser;
wherein the core stream diffuser and the bypass stream diffuser are formed as an integral unit.

12. The method of claim 11, wherein the core stream diffuser and the bypass stream diffuser are formed as an integral unit using three-dimensional (3D) printing.

13. The method of claim 12, wherein the integral unit is 3D printed with metal.

14. The method of claim 11, wherein the integral unit is formed to include compressor components.

15. The method of claim 11, wherein one or both of the core stream diffuser and the bypass stream diffuser are formed to include hollow vanes to permit engine services and/or instrumentation components to pass through.

16. The method of claim 11, wherein one or both of the core stream diffuser and the bypass stream diffuser are formed to include a radial channel and/or a circumferential channel to permit fluid flow there-through.

17. The method of claim 11, further comprising forming at least one surge chamber.

18. The method of claim 11, further comprising forming the core stream diffuser and the bypass stream diffuser to each include a plurality of vanes that are not uniformly spaced.

19. The method of claim 11, further forming an interstage bypass bleed, the interstage bypass comprising first and second circumferential chambers configured to enable a substantially even pressure distribution at an offtake.

20. An apparatus for use in a turbofan jet engine, the apparatus comprising:
means for diffusing a core air stream; and
means for diffusing a bypass air stream;
wherein the means for diffusing the core air stream and the means for diffusing the bypass air stream comprise an integral unit.
